(19) United States
(12) Patent Application Publication
(10) Pub. No.: US 2008/0164967 A1
(43) Pub. Date: Jul. 10, 2008

(54) INDUCTANCE ELEMENT

(76) Inventor: Naohiro MASHINO, Nagano (JP)

Correspondence Address: DRINKER BIDDLE & REATH (DC), 1500 K STREET, N.W., SUITE 1100, WASHINGTON, DC, 20005-1209, US

(21) Appl. No.: 11/960,112

(22) Filed: Dec. 19, 2007

(30) Foreign Application Priority Data
Dec. 20, 2006 (JP) P.2006-343226

(51) Int. Cl. H01F 27/28

(52) U.S. Cl. 336/180

(57) ABSTRACT

An inductance element includes: a first conductor formed into a rectangle spiral shape; and a second conductor formed into a rectangle spiral shape corresponding to the first conductor and provided to correspond to the first conductor element via a dielectric layer, wherein a first inner peripheral end of the first conductor and a second inner peripheral end of the second conductor are connected electrically in vicinity of a corner portion of a rectangle shape that the first conductor and the second conductor constitute.

This application is based on and claims priority from Japanese Patent Application No. 2006-343226, filed on Dec. 20, 2006, the entire contents of which are hereby incorporated by reference.

### BACKGROUND OF THE INVENTION

1. Technical Field

The present disclosure relates to an inductance element formed by a spiral conductor.

2. Background Art

The inductance element formed by shaping a conductor into a spiral shape is used in the power supply (a switching power supply), the filter circuit, and the like, for example. An inductance value of the inductance element is substantially proportional to a length of the conductor that is shaped into a spiral shape. Therefore, in order to get a high inductance value, a length of the conductor shaped into a spiral shape must be lengthened.

However, for the reason that the inductance element must be installed into the so-called mobile equipment such as the communication equipment, or the like, recently a reduction in size and weight is required of the inductance element. For this reason, in some cases there is a limit to a length of the conductor because the inductance element must be reduced in size. Therefore, such a structure has been proposed that a high inductance value can be obtained by stacking the conductors each formed into a spiral shape, for example (see e.g., JP-A-2004-319763).

However, in answer to a further miniaturization of the communication equipment, or the like in which the inductance element is employed, there is a need to reduce further the inductance element in size. Therefore, a smaller occupation area (occupied area) and a higher inductance value in the smaller occupation area are demanded of the inductance element.

### SUMMARY OF THE INVENTION

The present invention provides a new and useful inductance element, which can solve the above problem.

Aspects of the present invention provide an inductance element whose occupation area is small and whose inductance value is large.

In order to solve the above problem, according to one or more aspects of the present invention, an inductance element includes:

a first conductor formed into a rectangle spiral shape; and

a second conductor formed into a rectangle spiral shape corresponding to the first conductor and provided to correspond to the first conductor element via a dielectric layer;

wherein a first inner peripheral end of the first conductor and a second inner peripheral end of the second conductor are connected electrically in vicinity of a corner portion of a rectangle shape into which the first conductor and the second conductor are formed.

According to another aspect of the present invention, the rectangle spiral shape of the first conductor and the rectangle spiral shape of the second conductor may be formed so as to overlap with each other, when viewed from a top.

According to another aspect of the present invention, electric current flowing through the first conductor may flow in the same direction as electric current flowing through the second conductor.

According to another aspect of the present invention, the first inner peripheral end and the second inner peripheral end may be connected electrically in a range of 10% to 20% of the length of one side of the first or second conductor on the innermost periphery from the corner portion.

According to another aspect of the present invention, the first and second conductors may be formed into a square spiral shape.

According to another aspect of the present invention, the inductance element may be fabricated into a wiring substrate.

According to the present invention, the inductance element whose occupation area is small and whose inductance value is large can be provided.

### BRIEF DESCRIPTION OF THE DRAWINGS

FIG. 1 is a perspective view showing schematically an inductance element according to Example 1 of the present invention;

FIG. 2 is a plan view of the inductance element in FIG. 1;

FIG. 3 is a sectional view of the inductance element in FIG. 2;

FIG. 4 is a view showing the measured result of an inductance value of the inductance element according to Example 1;

FIG. 5 is a partial enlarged view (#1) of the inductance element in FIG. 1;

FIG. 6 is a partial enlarged view (#2) of the inductance element in FIG. 1;

FIG. 7 is a partial enlarged view (#3) of the inductance element in FIG. 1;

FIG. 8 is a perspective view (#1) of an inductance element formed to compare the inductance value;

FIG. 9 is a plan view of the inductance element in FIG. 8;

FIG. 10 is a perspective view (#2) of an inductance element formed to compare the inductance value;

FIG. 11 is a plan view of the inductance element in FIG. 10;

FIG. 12 is a perspective view (#3) of an inductance element formed to compare the inductance value;

FIG. 13 is a plan view of the inductance element in FIG. 12; and

FIG. 14 is a view comparing a difference in the inductance values caused due to a difference in structures based on simulations.

### DETAILED DESCRIPTION OF EXEMPLARY EMBODIMENTS

An inductance element according to the present invention includes: a first conductor formed into a rectangle spiral shape; and a second conductor formed into a rectangle spiral shape corresponding to the first conductor and provided to correspond to the first conductor element via a dielectric layer, wherein a first inner peripheral end of the first conductor and a second inner peripheral end of the second conductor are connected electrically in vicinity of a corner portion of a rectangle shape into which the first conductor and the second conductor are formed.

In the above inductance element, the available length of the conductor in the substantial occupation area of the inductance element can be prolonged by forming the spiral shape into not the round (circle) but the rectangle. For example, in the case where the element is a circle, the substantial occupation area of the inductance element becomes close to the area of the square whose one side is equal in length to a diameter of the circle (so-called longitudinal).

Accordingly, a number of areas in which the spiral is not formed (four corners of the square) are present in the areas the elements occupy substantially when the round spiral shape is employed. As a result, when the spiral shape is formed into the rectangle, the available length of the spiral in the occupation area of the inductance element can be prolonged.

Also, in the above inductance element, since the first conductor and the second conductor are provided to correspond to each other via the dielectric layer, an effect of increasing the inductance value caused due to the interaction between the mutual conductors can be enhanced. For example, when the electric currents flowing through the first conductor and the second conductor are directed in the same direction, the inductance value is increased due to the interaction between the first conductor and the second conductor.

In this case, it is preferable that the inner peripheral end of the first conductor and the inner peripheral end of the second conductor are connected electrically in vicinity of the corner portion of the rectangle shape that the first conductor and the second conductor constitute. In this case, lengths of the portions where the first conductor and the second conductor correspond to each other via the dielectric layer provided between them can be prolonged longer. Thus, an effect of increasing the inductance value caused due to the interaction between the first conductor and the second conductor can be enhanced.

Namely, since the first conductor and the second conductor are connected in vicinity of the corner portion, the lengths of the portions where the first conductor and the second conductor correspond to each other via the dielectric layer can be prolonged. The details of the structure that is able to enhance the inductance value will be described later.

Next, concrete examples of a configuration of the above inductance element will be explained with reference to the drawings hereinafter.

### Example 1

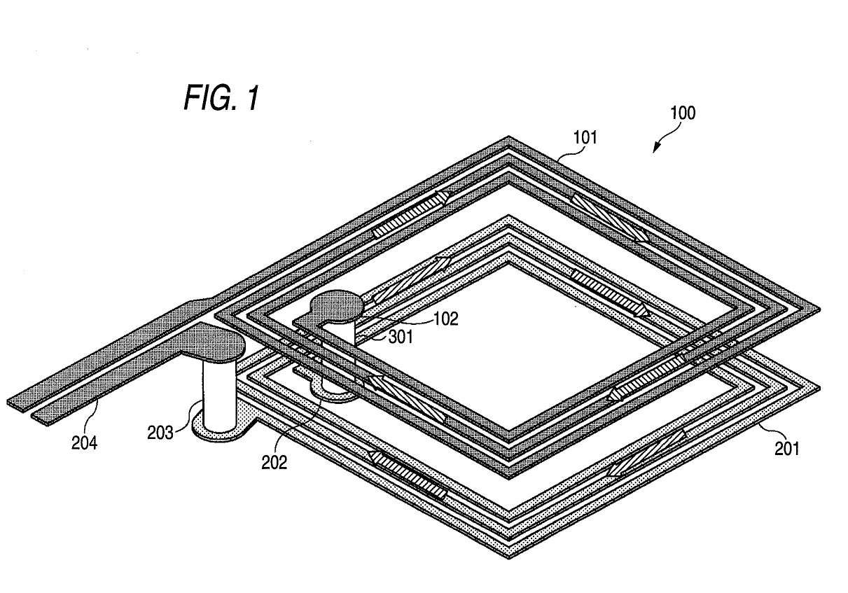

FIG. 1 is a view showing schematically an inductance element 100 according to Example 1 of the present invention. By reference to FIG. 1, an outline of the inductance element 100 shown in FIG. 1 have a first conductor 101 formed into a rectangle spiral shape, and a second conductor 201 formed into a rectangle spiral shape corresponding to the first conductor 101.

The first conductor 101 and the second conductor 201 are opposed to put a dielectric layer between them, whose illustration is omitted from FIG. 1. Namely, the first conductor 101 and the second conductor 201 are provided such that the rectangle spiral shape of the first conductor 101 and the rectangle spiral shape of the second conductor 201 are opposed to put the dielectric layer between them.

Also, an inner peripheral end 102 of the first conductor 101 and an inner peripheral end 202 of the second conductor 201 are connected electrically to each other by a plug 301, for example, in vicinity of a corner portion of the rectangle shape that the first conductor 101 and the second conductor 201 constitute.

Also, a connection portion 204 connected to an outer peripheral end of the second conductor 201 via a plug 203 is provided on the same planar surface as the first conductor 101. Thus, an electrical connection to the inductance element can be easily obtained.

The above inductance element 100 is fabricated into the wiring substrate or the wiring layer of the semiconductor package or the rewiring layer of the wafer level package or the chip size package in use. For example, when the above inductance element 100 is fabricated into the wiring substrate (multi-layered wiring substrate), the first conductor 101 and the second conductor 201 are patterned simultaneously with the pattern wirings being fabricated into the wiring substrate, and then the plug 301 is fabricated simultaneously with the via plugs being fabricated into the wiring substrate. Then, the insulating layer fabricated into the wiring substrate corresponds to the above dielectric layer.

Also, electric current flowing through the inductance element 100 flows clockwise from an outer peripheral end of the first conductor 101 to the inner peripheral end 102 of the first conductor 101. In addition, an arrow in FIG. 1 indicates the direction along which the electric current flows (this is similarly applied to following Figures).

Then, the electric current flows from the first conductor 101 toward the second conductor 201 via the plug 301 explained above. Then, the electric current flows through the second conductor 201 from the inner peripheral end 202, to which the plug is connected, toward the outer peripheral end clockwise. Namely, the turning direction of the flow of the electric current becomes equal to that in the first conductor 101 with respect to the spiral.

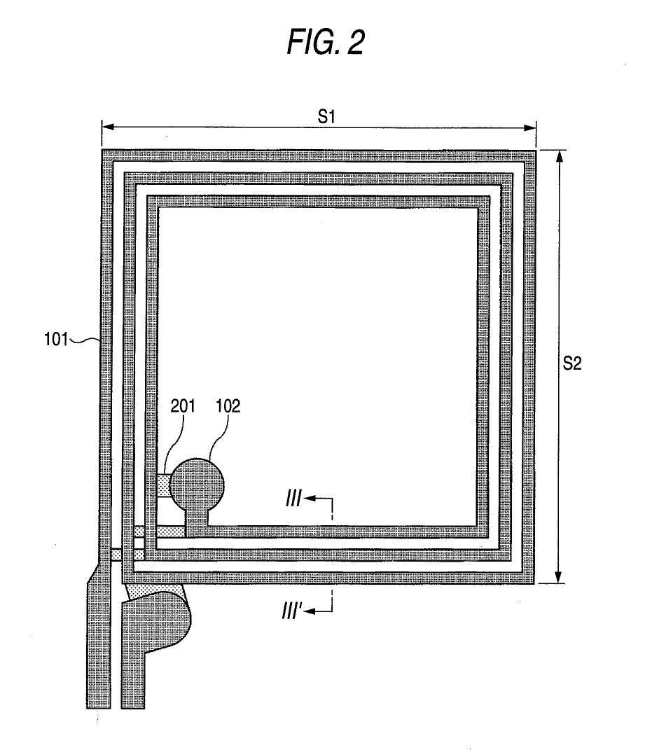

FIG. 2 is a plan view of the inductance element 100 shown in FIG. 1. Here, the same reference symbols are affixed to the same portions as those explained above, and their explanation will be omitted (this is similarly true of following Figures).

By reference to FIG. 2, the inductance element 100 according to the present example is characterized in that, when viewed from the top, the spiral shape of the first conductor 101 and the spiral shape of the second conductor 201 are formed so as to overlap with each other. Also, in the present example, a length of one side S1 of the outer periphery of the rectangle shape of the first conductor 101 (the second conductor 201) is set equal to a length of one side S2 of the outer periphery that orthogonally intersect with the side S1. Namely, in the present example, the above rectangle shape is constructed as a square. But the present invention is not restricted to this, and the inductance element 100 may be constructed such that the side S1 and the side S2 are different from each other.

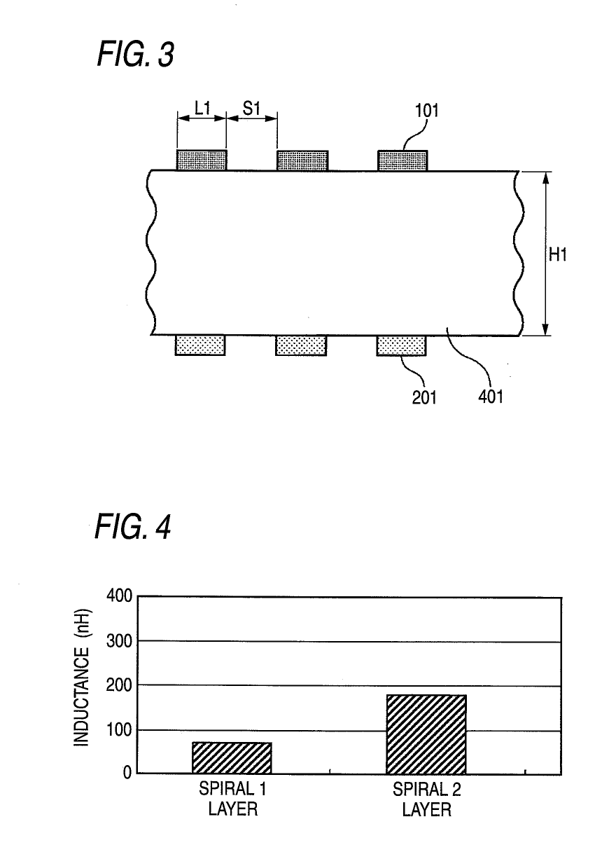

Also, FIG. 3 shows a sectional view taken along a III-III′ line in FIG. 2. By reference to FIG. 3, it can be seen that, in the inductance element 100 according to the present example, the first conductor 101 and the second conductor 201 are opposed mutually to put a dielectric layer 401 (its illustration is omitted in FIG. 1) between them.

Also, in the above configuration, a dielectric layer (insulating layer) for covering the first conductor 101 or a dielectric layer for covering the second conductor 201 may be further formed. Also, the dielectric layer for covering the first conductor 101, the dielectric layer for covering the second conductor 201, and the dielectric layer 401 may be formed integrally. Namely, the first conductor 101 and the second conductor 201 may be embedded in a predetermined dielectric layer.

In the above inductance element 100, the rectangle spiral shape is employed instead of the round (circular) spiral shape. Therefore, a length of the first conductor 101 (a length of the second conductor 201) that can be formed in a substantial occupation area of the inductance element can be prolonged.

For example, normally the wiring substrate is formed into the rectangle shape, and normally the electronic component mounted on the wiring substrate has the rectangle shape as the planar shape (the occupation area when it is arranged on the wiring substrate). Therefore, when the electronic components are arranged on the wiring substrate, an arrangement is designed on the assumption that the components to be mounted have the rectangle shape.

Therefore, when the circular inductance element is fabricated into the wiring substrate based on a relationship of the arrangement of the electronic components, a substantial occupation area is the square shape one side of which is equal in length to a diameter of the circle.

Accordingly, a number of areas in which the spiral is not formed (four corners of the square) are present in the areas the elements occupy substantially when the round spiral shape is employed. As a result, when the rectangle spiral shape is employed, a length of the spiral that can be formed in the occupation area of the inductance element can be prolonged.

For example, a difference in available length of the spiral shape caused due to a difference in the spiral shape is compared by taking the case where the spiral shape is formed in the square area whose one side is 4 mm, as an example. In a situation that a width and a space of the conductor are set to 0.1 mm respectively, a length of the spiral is about 66 mm when the spiral shape is circular whereas a length of the spiral is about 84 mm when the spiral shape is square.

In this manner, when the spiral shape is square, an available length of the spiral in the occupation area of the element can be prolonged.

Also, since the first conductor 101 and the second conductor 201 are provided to oppose mutually via the dielectric layer 401, the above inductance element 100 can achieve such an advantage that an inductance value is increased because of mutual influences of the first and second conductors 101 and 102. For example, as explained above, when electric current flowing through the first conductor 101 and electric current flowing through the second conductor 201 (the direction of spiral shapes) flow in the same direction, an inductance value is increased because of the interaction between the first conductor 101 and the second conductor 201.

FIG. 4 is a view showing the measured result of the inductance value of the inductance element 100 according to the present example. Upon forming the inductance element 100, one side (S1, S2) of the square shape shown in FIG. 2 is set to 4 mm, a width L1 of the first conductor 101 (the second conductor 201) shown in FIG. 3 is set to 0.1 mm, and a space S1 between neighboring conductors is set to 0.1 mm. Also, the first conductor 101 and the second conductor 201 are formed of Cu. Also, the dielectric layer (insulating layer) 401 is formed of the epoxy-based resin material, for example. A thickness H1 was set to 0.8 mm. A relative dielectric constant of the dielectric layer was 4.8 and a dielectric loss tangent (tan δ) was 0.015.

By reference to FIG. 4, an inductance value of the inductance element 100 (represented as a spiral 2 layer in FIG. 4) was about 177.7 nH. Also, for the sake of comparison, an inductance value when the conductor (spiral) is not stacked and only on layer (only the first conductor 101) is formed was 68.3 nH. Namely, in the present example, the inductance value was increased larger by 30% than the case where the inductance value obtained when one spiral layer is used is simply doubled (136.6 nH).

From the above results, in the inductance element 100 according to the present example, it was confirmed that the inductance value higher than that obtained by increasing a line length twice simply can be obtained due to the interaction between the stacked conductors when the (spiral-shaped) conductors are stacked.

Also, the inductance element 100 according to the present example is characterized in that the inner peripheral end 102 of the first conductor 101 and the inner peripheral end 202 of the second conductor 201 are connected electrically mutually by the plug 301 near the corner portion of the rectangle shape that the first conductor 101 and the second conductor 201 constitute.

With the above configuration, lengths of the first conductor 101 and the second conductor 201 that are opposed to each other to put the dielectric layer 401 between them can be formed longer. Thus, the above-described advantage of enhancing the inductance value can be improved much more.

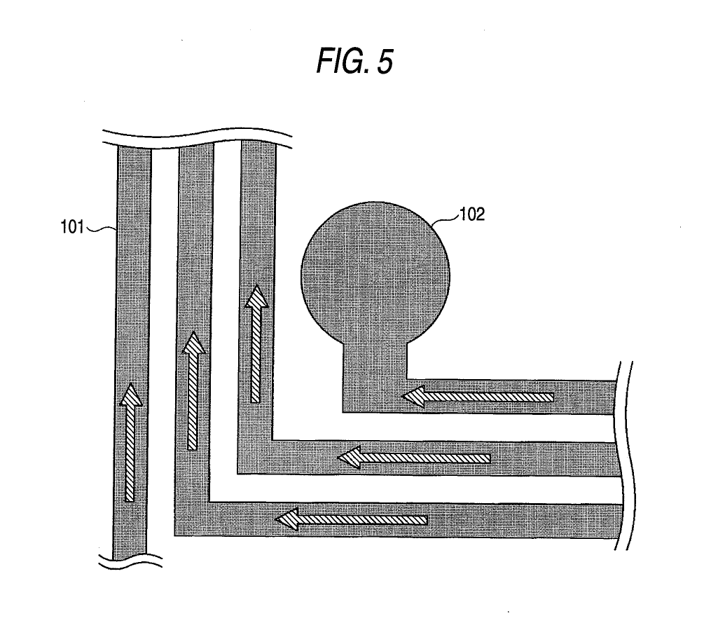

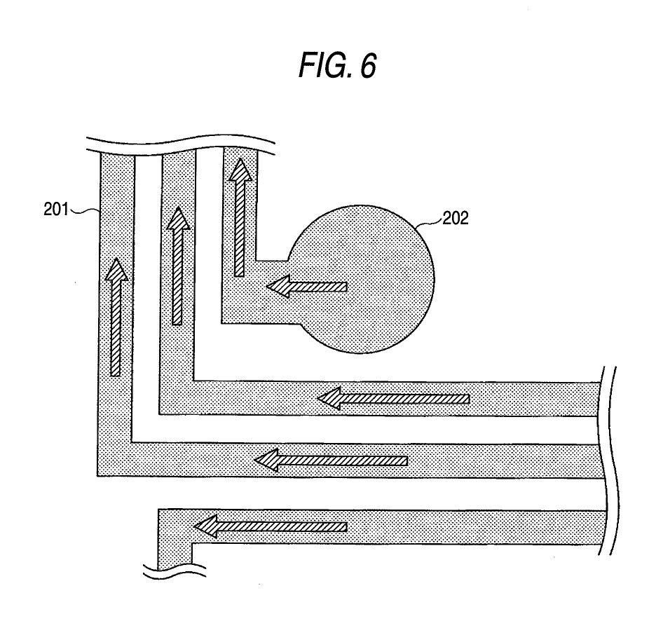

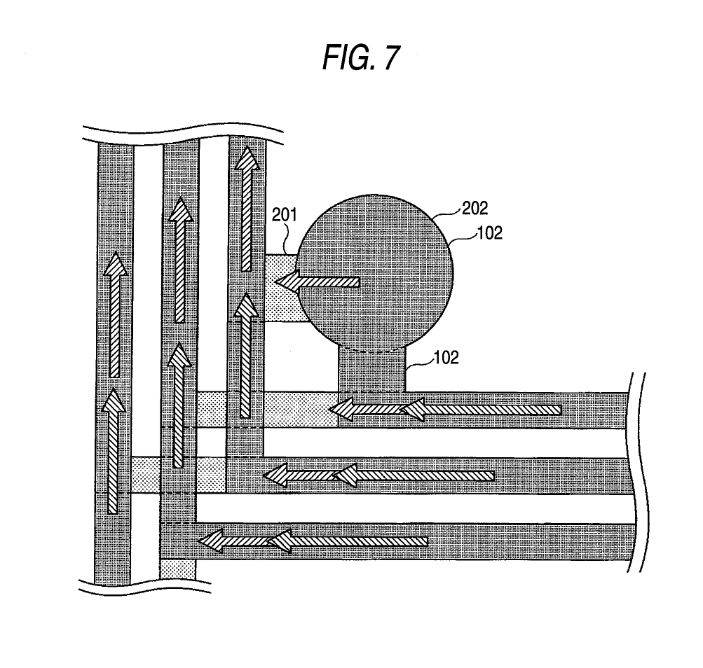

The above structure will be explained with reference to FIG. 5 to FIG. 7 hereunder. FIG. 5 is a plan view showing a part of the neighborhood of the inner peripheral end 102 of the first conductor 101 in an enlarged fashion. Also, FIG. 6 is a plan view showing a part of the neighborhood of the inner peripheral end 202 of the second conductor 201 in an enlarged fashion. Also, FIG. 7 shows the first conductor 101 in FIG. 5 and the second conductor 201 in FIG. 6 that are overlapped with each other, and corresponds to a plan view showing the corner portion where the first conductor 101 and the second conductor 201 are connected and its neighborhood in an enlarged fashion.

By reference to FIG. 5, the electric current flowing through the first conductor 101 flows from the outer peripheral side of the first conductor 101 toward the inner peripheral side clockwise, as described above. Then, the electric current flows from the inner peripheral end 102 located near the corner portion of the square shape of the first conductor 101 toward the second conductor 201 via the plug 301 (shown in FIG. 1).

Then, by reference to FIG. 6, the electric current flowing through the second conductor 201 flows from the inner peripheral side of the second conductor 201 toward the outer peripheral side clockwise, as described above, i.e., flows in the same turning direction as that of the electric current of the first conductor 101.

Next, by reference to FIG. 7, the electric current flowing through the first conductor 101 and the electric current flowing through the second conductor 201 flow in the same direction except the neighborhood of the corner portion of the square shape constituting the spiral shape, and flow substantially in the same direction as a whole.

In this case, the first conductor 101 and the second conductor 201 are connected mutually in vicinity of the corner portion of the square spiral shape. Thus, lengths of the portions, which are opposed to each other to put the dielectric 401 between them, of the first conductor 101 and the second conductor 201 can be formed longer.

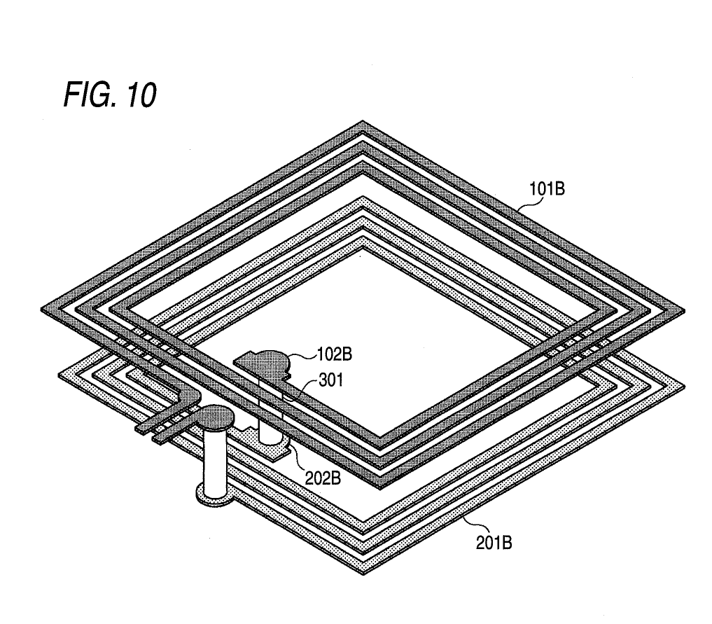

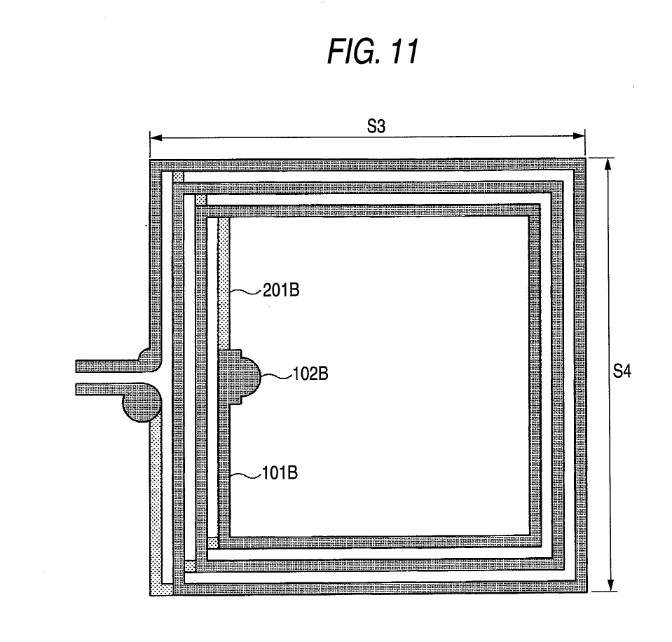

For example, assume that a connection point between the first conductor 101 and the second conductor 201 (referred simply to as a connection point) is provided near a middle of one side of the square on the innermost periphery of the first conductor 101 (the second conductor 201). In this case, the portion where the first conductor 101 on the innermost periphery does not correspond to the second conductor 201 (the non-overlapped portion when viewed from the top) and the portion where the second conductor 201 on the innermost periphery does not correspond to the first conductor 101 (the non-overlapped portion when viewed from the top) are enlarged (an example of such structure will be described later with reference to FIG. 10 and FIG. 11).

In contrast, when the connection point is formed near the corner portion, the portions where the first conductor 101 and the second conductor 201 are opposed to each other (the overlapped portions when viewed from the top) can be enlarged. Therefore, in the inductance element 100 according to the present example, an effect of increasing the inductance value caused due to the interaction between the first conductor 101 and the second conductor 201 can be enhanced. Also, the “near the corner portion of the square shape” in the above case signifies “in a range of 10% to 20% of the length of one side of the first or second conductor on the innermost periphery from the corner portion”.

Also, the inner peripheral end 102 of the first conductor 101 protrudes to the inside of the spiral shape of the first conductor 101, the inner peripheral end 202 of the second conductor 201 protrudes to the inside of the spiral shape of the second conductor 201, and respective the inner peripheral ends 102, 202 are connected via the plug 301. According to the above configuration, lengths of portions where the first conductor 101 and the second conductor 201 are opposed to each other can be prolonged.

Also, in the inductance element 100 according to the present example, the first conductor 101, the second conductor 201, and the plug 301 are formed of Cu, for example, and the dielectric layer 401 is formed of the resin material, for example. However, these materials are given as an example, and the present invention is not restricted to these materials.

For example, the first conductor 101, the second conductor 201, and the plug 301 may be formed of the metal material such as Au, Ag, Al, or the like, or may be formed of the alloy material containing them. Also, the dielectric layer 401 may be formed of other insulating material such as glass, ceramic, or the like.

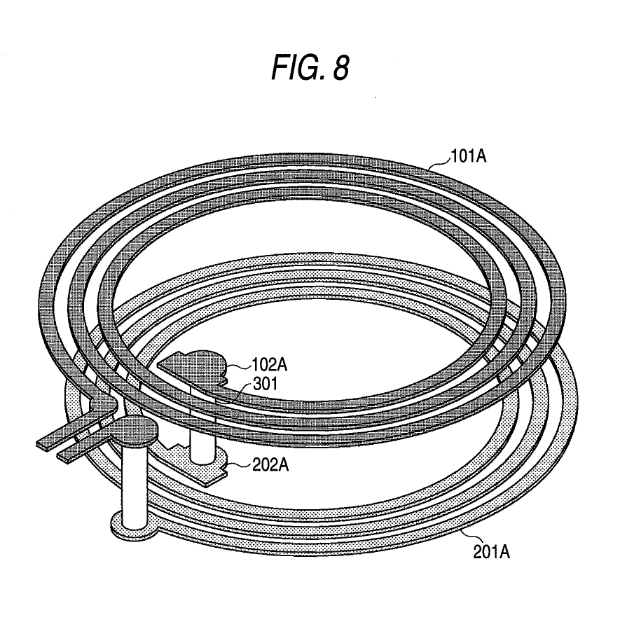

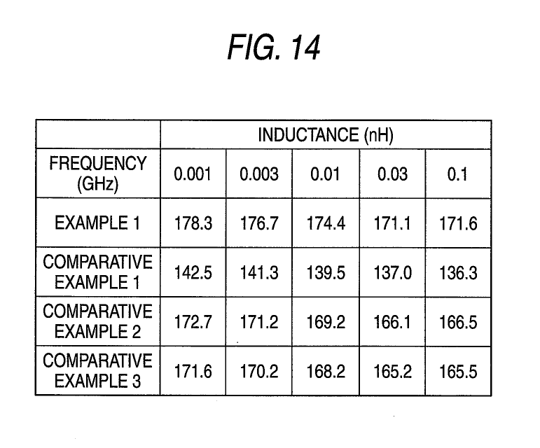

Next, respective inductance values of the above inductance element 100 (referred to as “Example 1” hereinafter) and inductance elements in Comparative Example 1 to Comparative Example 3 in which the configuration of the inductance element 100 is changed respectively are compared based on the simulation as described below. First, features of the structures in Comparative Example 1 to Comparative Example 3 will be explained with reference to FIG. 8 to FIG. 13 hereunder, and numerical values of the simulation results will be explained with reference to FIG. 14 hereunder.

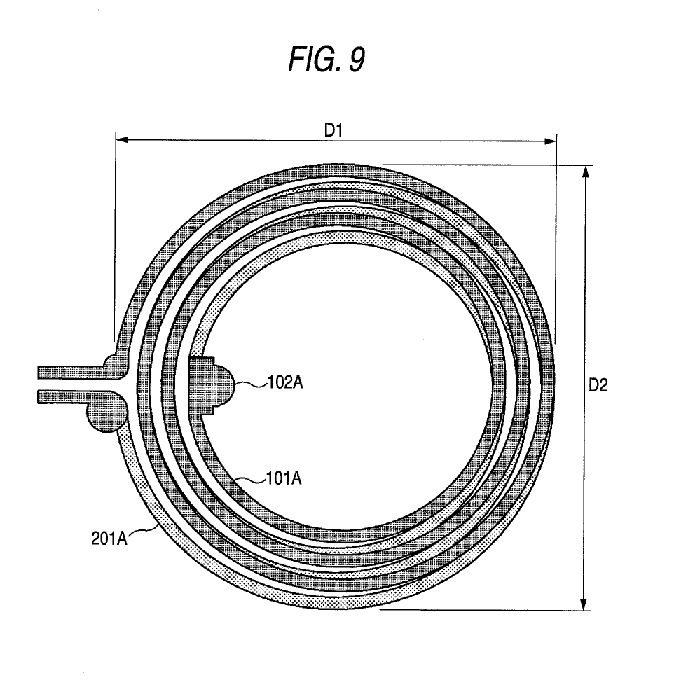

FIG. 8 is a perspective view showing a configuration of an inductance element in Comparative Example 1 (referred to as “Comparative Example 1” hereinafter), and FIG. 9 is a plan view showing the same. In this case, material (physical property values), line width, space, and the like constituting Comparative Example are set similarly to those of Example 1. In following Figures, illustrations of the dielectric layer in Comparative Example 1 to Comparative Example 3 are omitted herein.

By reference to FIG. 8 and FIG. 9, Comparative Example 1 is different from Example 1 in that both a first conductor 101A and a second conductor 201A are formed into a circular spiral shape. Other configurations are similar to those of Example 1. In this case, an inner peripheral end 102A of the first conductor 101A and an inner peripheral end 202A of the second conductor 201A are connected via the plug 301. Also, diameters D1, D2 of circles on the outermost periphery constituting the spiral shape are set to 4 mm.

FIG. 10 is a perspective view showing the configuration of an inductance element in Comparative Example 2 (referred to as “Comparative Example 2” hereinafter), and FIG. 11 is a plan view showing the same.

By reference to FIG. 10 and FIG. 11, in Comparative Example 2, a connection point between a first conductor 101B and a second conductor 201B is provided near a middle of one side of the square on the inner periphery of the first conductor 101B (the second conductor 201B). Namely, an inner peripheral end 102B of the first conductor 101B, an inner peripheral end 202B of the second conductor 201B, and the plug 301 are formed near a middle of one side of the above square. In this case, the portion where the first conductor 101B on the innermost periphery is not opposed to the second conductor 201B (the non-overlapped portion when viewed from the top) and the portion where the second conductor 201B on the innermost periphery is not opposed to the first conductor 101B (the non-overlapped portion when viewed from the top) are enlarged rather than Example 1. Further, a length of one side (S3, S4) of the square is the same as that of Example 1.

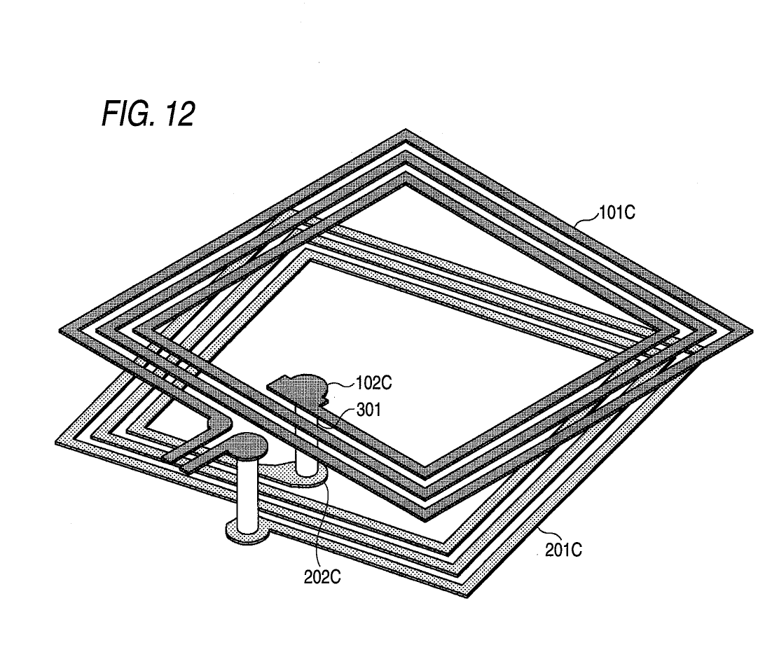

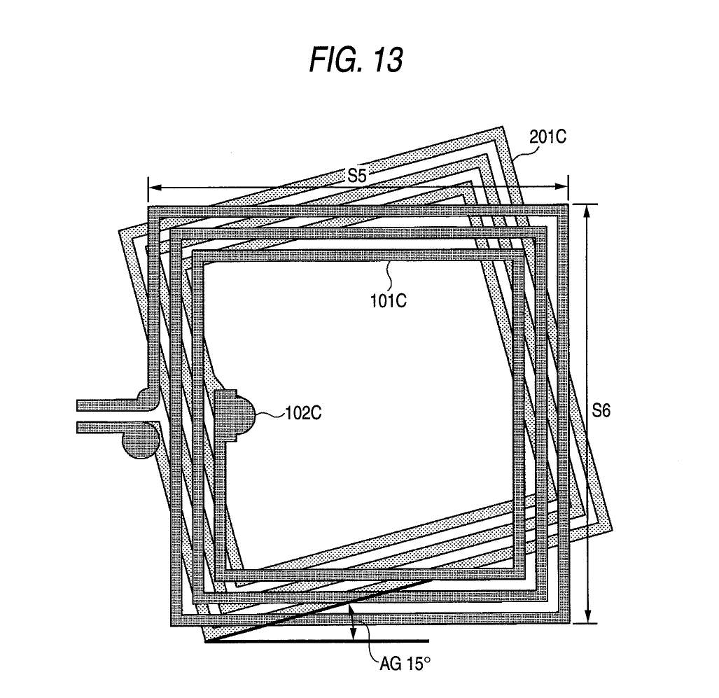

FIG. 12 is a perspective view showing the configuration of an inductance element in Comparative Example 3 (referred to as “Comparative Example 3” hereinafter), and FIG. 13 is a plan view showing the same.

By reference to FIG. 12 and FIG. 13, Comparative Example 3 is different from Comparative Example 2 in that spiral shapes of a first conductor 101C and a second conductor 201C do not correspond to each other (the spiral shapes do not overlap with each other when viewed from the top). The second conductor 201C is stacked on the first conductor 101C in a state that a turning angle AG is deviated by 15° while a center of the square is set as a center of turn.

Also, similarly to Comparative Example 2, an inner peripheral end 102C of the first conductor 101C, an inner peripheral end 202C of the second conductor 201C, and the plug 301 are formed near a middle of one side of the spiral square. In this case, a length of one side (S5, S6) of the square is set equal to that of Example 1.

FIG. 14 is a view showing the results of the inductance values in Example 1 and Comparative Example 1 to Comparative Example 3 calculated based on the simulations.

First, the inductance values in Example 1 and Comparative Example 1 are compared. The reason why the inductance value in Comparative Example 1 is reduced smaller than that in Example 1 may be considered like that such inductance value is affected mainly by a difference in line length of the conductors. This is because a diameter of the spiral in Comparative Example 1 is set identical to a length of one side of the square in Example 1 in light of the occupation area of the element. Therefore, a line length of the spiral in Example 1 is prolonged and the inductance value is increased.

Also, in Comparative Example 1, because the spiral is a circular shape, the portions where the conductors are stacked obliquely are increased when viewed from the top as shown in FIG. 9. Namely, the area where the directions of the electric currents do not correspond to each other between the stacked conductors are formed much more. Therefore, it may be considered that an effect of enhancing the inductance value due to the interaction between the opposing conductors is reduced.

Also, in Comparative Example 2, as described above, the portions where the stacked conductors are not opposed to each other (the non-overlapped portions when viewed from the top) are increased larger than Example 1. Therefore, an effect of enhancing the inductance value due to the interaction between the opposing conductors is reduced, and the inductance value is reduced smaller than Example 1.

Also, in Comparative Example 3, the inductance value is further reduced smaller than Comparative Example 2 due to the influence that respective spiral shapes of the stacked conductors are not opposed to each other (the spiral shapes do not overlap with each other when viewed from the top) in addition to the influence in Comparative Example 2.

In view of the simulation results, it was confirmed that the inductance value in Example 1 is higher than all inductance values in Comparative Example 1 to Comparative Example 3 and that the high inductance value can be obtained by the inductance element of the present invention.

While the present invention is described with reference to the preferred examples, the present invention is not limited to the above particular examples, and various variations and modifications can be applied in a scope of the present invention.

For example, while the above examples are described by taking the case where the spiral conductors are stacked as two layers, the present invention is not limited to this, and the configuration that the spiral conductors are stacked in multiple layers may be employed.

According to the present invention, the inductance element whose occupation area is small and whose inductance value is large can be provided.

What is claimed is:

1. An inductance element, comprising:
a first conductor formed into a rectangle spiral shape; and
a second conductor formed into a rectangle spiral shape corresponding to the first conductor and provided to correspond to the first conductor element via a dielectric layer,
wherein a first inner peripheral end of the first conductor and a second inner peripheral end of the second conductor are connected electrically in vicinity of a corner portion of a rectangle shape that the first conductor and the second conductor constitute.

2. The inductance element according to claim 1, wherein
the rectangle spiral shape of the first conductor and the rectangle spiral shape of the second conductor are formed so as to overlap with each other, when viewed from a top.

3. The inductance element according to claim 2, wherein
electric current flowing through the first conductor flows in the same direction as electric current flowing through the second conductor.

4. The inductance element according to claim 1, wherein
the first inner peripheral end and the second inner peripheral end are connected electrically in a range of 10% to 20% of the length of one side of the first or second conductor on the innermost periphery from the corner portion.

5. The inductance element according to claim 1, wherein
the first and second conductors are formed into a square spiral shape.

6. The inductance element according to claim 1, wherein
the inductance element are fabricated into a wiring substrate.
